(19) United States
(12) Patent Application Publication
(10) Pub. No.: US 2003/0060320 A1
(43) Pub. Date: Mar. 27, 2003

(54) Reversible gear box for use with an auger

(75) Inventor: Brent Woodcock, Aberdeen (CA)

Correspondence Address: ADE & COMPANY, 1700-360 MAIN STREET, WINNIPEG, MB, R3C3Z3, CA

(73) Assignee: BTG Manufacturing Inc., Saskatchewan (CA)

(21) Appl. No.: 09/962,107

(22) Filed: Sep. 26, 2001

(51) Int. Cl. F16H 48/06

(52) U.S. Cl. 475/230

(57) ABSTRACT

A reversing gear box is provided for use with an auger having a housing, a flight rotatably mounted therein and a motor for driving rotation of the flight. The gear box includes a drive shaft coupled to the motor and a driven shaft coupled to the flight of the auger at right angles to the driven shaft. A drive gear is mounted on an end of the drive shaft between a pair of confronting driven gears mounted on the driven shaft. A sliding element is slidably mounted on the driven shaft between a forward position and a rearward position for selectively coupling the driven shaft to the drive gear via the driven gears. In the forward and rearward positions, rotation of the drive shaft in a forward direction corresponds to rotation of the driven shaft in respective forward and rearward directions. An actuator displaces the sliding element between the forward and rearward positions as desired.

### FIELD OF THE INVENTION

This invention relates to an auger and more particularly to a reversible gear box for use with an auger.

### BACKGROUND

Augers are commonly used for handling particulate material such as seed and the like. Augers generally comprise a tubular housing having a flight mounted for rotation therein. A motor is generally coupled to a shaft of the auger using a belt and pulleys. The auger is thus arranged to be rotated in a forward direction for transporting particulate material from a loading end to a discharge end of the housing. On occasion however, it is desirable to operate the auger in a reverse direction. Operation of the auger in reverse is generally required when it is desirable to empty the auger for use in a different application or to clean out the auger in the event the auger should become plugged.

Operation of a conventional auger in reverse is normally accomplished by removing the drive belt extending between the motor output and the shaft of the auger and replacing the belt thereon in a twisted, figure eight like pattern. The flight of the auger will thus be rotated in the reverse direction. The task of reorienting the drive belt however is difficult due to the tension in the belt and requires an awkward manipulation of the belt to replace it on the auger. Furthermore, the drive belts are generally not intended for repeated use in a twisted arrangement which may result in excessive wear or slipping of the belt during operation.

### SUMMARY

According to the present invention there is provided a gear box for use with an auger comprising an elongate auger housing, a flight mounted in the auger housing for rotation about a longitudinal axis and a motor having an output for driving rotation of the flight, the gear box comprising:

a gear box housing;

a main shaft rotatably mounted within the gear box housing;

a main gear mounted on the main shaft;

a secondary shaft rotatably mounted within the gear box housing;

a pair secondary gears including a forward gear and a rearward gear mounted spaced apart on the secondary shaft, and

a sliding element mounted on the secondary shaft and arranged to couple the secondary gears to the secondary shaft, the sliding element being slidably movable in a longitudinal direction of the secondary shaft between:

a forward position in which the forward gear is engaged to rotate with the secondary shaft and the forward gear is engaged with the main gear such that rotation of the main shaft in a forward direction corresponds to rotation of the secondary shaft in a forward direction; and

a rearward position in which the rearward gear is engaged to rotate with the secondary shaft and the rearward gear is engaged with the main gear such that rotation of the main shaft in the forward direction corresponds to rotation of the secondary shaft in a rearward direction opposite to the forward direction of the secondary shaft in the forward position of the sliding element;

one of the main shaft and the secondary shaft being arranged to be coupled to the output of the motor for rotation therewith and the other shaft being arranged to be coupled to the flight of the auger for rotation therewith.

The use of a gear box which can be mounted on a conventional auger allows the auger to be operated in reverse on occasion without requiring awkward manipulation of the drive belt. The gear box ensures that the motor remains securely coupled to the flight of the auger during either forward or rearward rotation of the auger while permitting the auger to be easily converted between forward and rearward modes of operation with little effort required.

The main shaft preferably extends substantially perpendicularly to the secondary shaft and terminates at a free end adjacent to the secondary shaft. The main gear and the pair of secondary gears in this arrangement each preferably comprise a bevel gear.

Preferably the forward gear and the rearward gear engage respective opposing sides of the main gear in the forward and rearward positions respectively.

The main shaft may be arranged to be coupled to the output of the motor for rotation therewith while the secondary shaft is arranged to be coupled to the flight of the auger for rotation therewith. Alternatively, the main shaft can be coupled to the flight of the auger with the secondary shaft coupled to the motor.

The sliding element is preferably movable into a neutral position, intermediate of the forward position and the rearward position, in which main shaft rotates independently from the secondary shaft.

There may be provided an actuator coupled to the sliding element which is arranged to control a longitudinal position of the sliding element along the secondary shaft between the forward and rearward positions.

There may be provided a bearing coupled between the actuator and the sliding element permitting the sliding element to rotate freely with the secondary shaft while restricting a longitudinal positioning of the sliding element along the shaft.

The actuator is preferably arranged to be coupled to the sliding element on diametrically opposing sides of the sliding element.

The sliding element may be coupled to the secondary shaft for rotation therewith while permitting relative sliding movement therebetween in a longitudinal direction of the secondary shaft.

Preferably, the main shaft and the secondary shaft are rotatably supported on the housing by respective roller bearings.

In one embodiment, both the secondary gears are preferably engaged with the main gear in both the forward and rearward positions of the sliding element. The secondary gears are thus arranged for rotation in opposite directions about the secondary shaft. The sliding element in this embodiment is preferably selectively coupled to the forward and rearward gears for rotation with a respective one of the forward and rearward gears in the forward and rearward positions respectively.

The secondary gears may be rotatably supported on the secondary shaft by respective bearings.

Each of the secondary gears may include a socket at one end thereof arranged to receive an end of the sliding element therein having a mating cross section for rotation together in a respective one of the forward and rearward positions.

The sliding element may be supported on the secondary shaft between the secondary gears and is preferably arranged to engage at most only one of the secondary gears at any given longitudinal position along the secondary shaft.

In an alternative embodiment, the sliding element mounts the secondary gears on the secondary shaft for rotation with the secondary shaft while permitting sliding movement of the secondary gears along the secondary shaft in a longitudinal direction of the shaft with the sliding element between the forward and rearward positions thereof.

The sliding element and the secondary shaft may have respective mating cross sections for restricting relative rotational movement while permitting longitudinal sliding movement therebetween.

There may be provided an actuator arranged to control a longitudinal position of the sliding element and secondary gears mounted thereon along the secondary shaft.

### BRIEF DESCRIPTION OF THE DRAWINGS

In the accompanying drawings, which illustrate exemplary embodiments of the present invention:

FIG. 1 is a side elevational view of an auger with the gear box mounted thereon.

FIG. 2 is a side elevational view of the gearbox of FIG. 1 shown with a portion of the gear box housing removed.

FIG. 3 is a cross sectional view of the gear box along the line 3-3 of FIG. 2.

FIG. 4 is cross sectional view of the gear box along the line 4-4 of FIG. 2.

FIG. 5 is a sectional side elevational view of an alternative embodiment of the gear box.

FIG. 6 is a partly sectional view along the line 6-6 of FIG. 5 showing the slide member engaging an end face of one of the driven gears.

FIG. 7 is a plan view of the gear box along the line 7-7 of FIG. 6.

### DETAILED DESCRIPTION

Referring to accompanying drawings there is illustrated a reversible gear box generally indicated by reference numeral 10. The gear box 10 is arranged for use with an auger 12 such that the auger is easily permitted to operate in both forward and rearward directions.

The auger 12 includes an elongate auger housing 14 which is supported at an upward angle to extend from a bottom end 16 to a top end 18. A feed chute 20 is located adjacent the bottom end 16 for loading particulate material into the auger 12. An outlet 22 is located adjacent the top end 18.

A flight 24 is mounted within the auger housing 14 for rotation about a shaft 26 of the flight having a longitudinally extending axis. The gear box 10 couples a motor 28 of the auger to the shaft 26 for driving the shaft in both the forward and rearward directions.

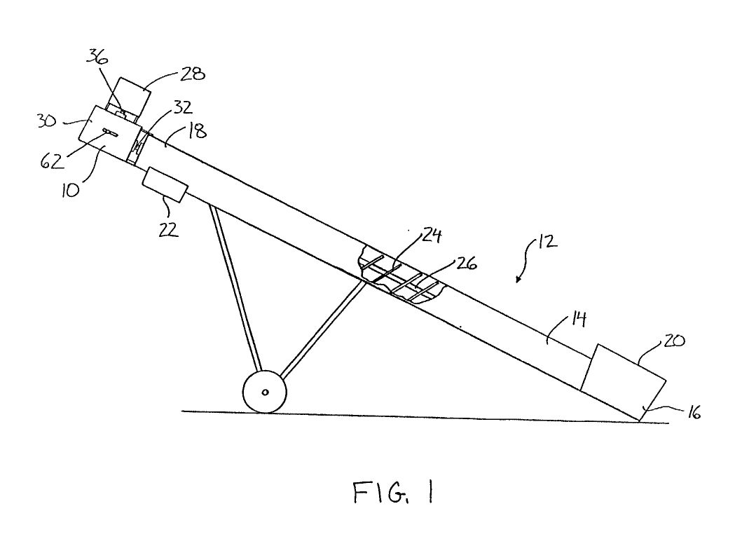

A first embodiment of the gear box 10 is shown in detail in FIGS. 1 through 4. The gearbox 10 includes a gear box housing 30 which is coupled to the auger housing 14. A driven shaft 32 is rotatably supported to extend through the gear box housing by a pair of bearings 34 mounted at respective ends of the housing. The driven shaft 32 is arranged to couple to the shaft 26 of the auger for rotation therewith. Depending upon the location of the gear box housing 30 on the auger housing 14, the driven shaft 32 may be coupled to the auger shaft 26 directly as shown, or through any suitable transmission such as a pulley arrangement with an externally mounted auger drive shaft extending alongside the auger housing when a motor of the auger is centrally located as in many conventional augers.

A main drive shaft 36 is arranged to be coupled to the motor 28 and extends through the housing at right angles to the driven shaft 32. The drive shaft 36 is supported on the housing by a pair of bearings 38 which are mounted at respective longitudinal positions along the shaft such that a free end 40 of the shaft is supported adjacent the driven shaft 32. A drive gear 42 couples to the free end 40 of the drive shaft for rotation with the shaft. The drive gear 42 is in the form of a bevel gear which tapers towards the driven shaft 32.

The driven shaft 32 includes a forward driven gear 44 and a rearward driven gear 46 mounted thereon for rotation with the shaft. The driven shaft 32 includes a slide portion 48 which extends the length of the housing. A collar 50 is mounted on the slide portion 48 of the driven shaft for mounting the forward and rearward driven gears 44 and 46 thereon for longitudinal sliding movement along the shaft. Both the slide portion 48 and the collar 50 have respective mating hexagonal cross sections such that the collar and driven gears rotate with the slide portion of the driven shaft while permitting relative longitudinal sliding movement therebetween.

The driven gears 44 and 46 are mounted on the collar 50 at longitudinally spaced apart locations. The driven gears are in the form of confronting bevel gears which are tapered towards each other and are arranged to engage opposing sides of the drive gear 42 when the respective driven gear is slidably engaged with the drive gear during either forward or rearward rotation of the flight. The drive gear and driven gears are bevel gears having a profile extending at approximately 45 degrees from the respective shafts such that the gears are arranged to mate with each other when the shafts are oriented perpendicularly.

In this arrangement the forward driven gear engages the drive gear in the forward position wherein forward rotation of the drive shaft corresponds to forward rotation of the driven shaft. Accordingly, the rearward driven gear engages the drive gear in the rearward position wherein forward rotation of the drive corresponds to rearward rotation of the driven shaft.

The driven shaft 32 includes a threaded end portion 52 which is arranged to threadably receive a nut 54 thereon for securing a longitudinal positioning of the driven shaft 32 within the housing. The collar 50 remains slidably engaged on the driven shaft 32 permitting longitudinal displacement thereof for selectively engaging one of the driven gears 44 or 46 with the drive gear 42.

An actuator 56 is coupled between the collar 50 and the housing for controlling the longitudinal positioning of the collar within the housing. The actuator 56 includes an arc-shaped coupling member 58 which is pivotally mounted to the collar 50 at respective ends of the member on a bearing 60 mounted between the member and the collar.

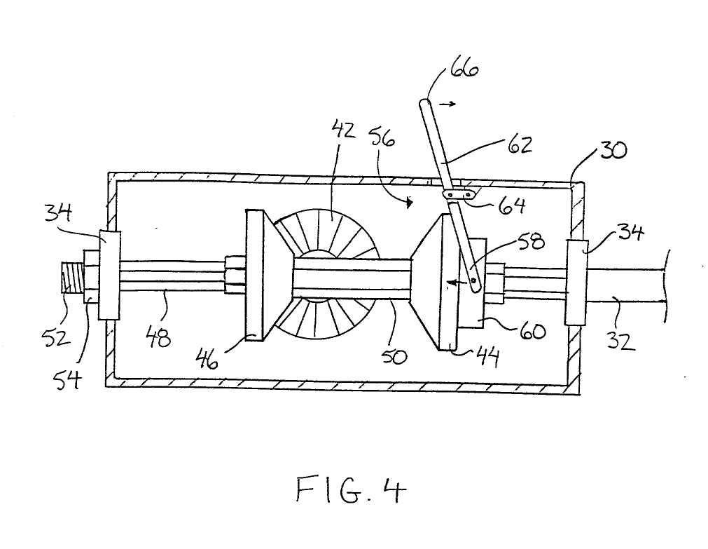

The coupling member 58 has a radius of curvature which is greater than a radius of the driven gears such that the coupling member is free to pivot about an axis extending between the ends of the member with sufficient clearance to pass over the driven gears as shown in FIG. 4. The bearing 60 allows the coupling member to rotate freely about the collar 50 while restricting longitudinal movement of the collar relative to the housing as the driven gears and collar are rotated in operation.

A lever 62 is mounted on the coupling 58 and extends generally radially outward from the driven shaft 32 past a wall of the housing 30. A link 64 pivotally couples the lever 62 to a lug on the housing such that deflection of a free end 66 of the lever will pivot the lever about the link 64 for longitudinally displacing the collar 50 along the driven shaft 32. The link 64 accommodates a required variation in length of the lever as the collar is displaced relative to the housing.

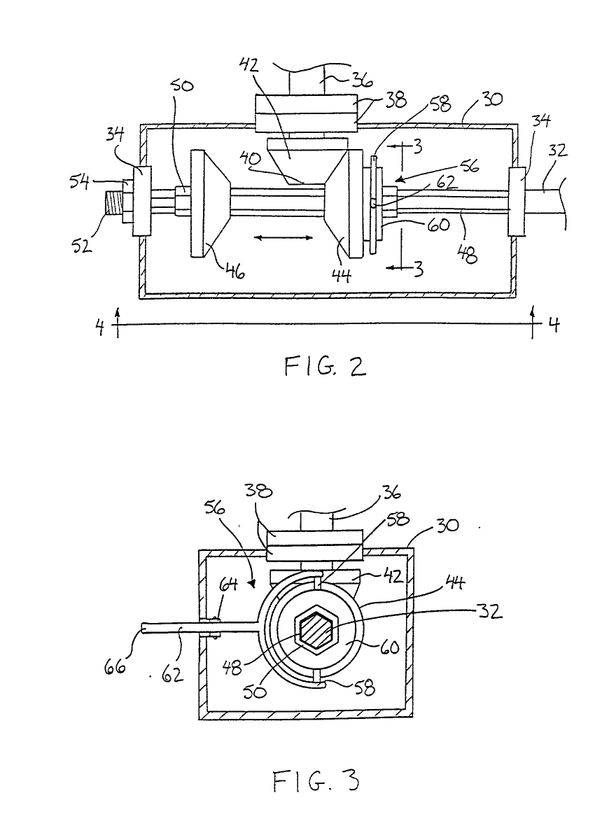

In use, the auger 12 may be switched from operating in a forward position as shown in FIG. 2 to a rearward position as shown in FIG. 4 by pivotally deflecting the lever 62 of the actuator about the link 64. Securing the lever 62 while the gearbox is in the forward position allows the auger to be used with the flight rotating in a forward direction for normal operation of the auger. If it is desired to reverse the direction of rotation of the flight the lever 62 may be deflected and secured in the position as shown in FIG. 4 such that the auger operates in the rearward position.

The collar 50 is slidable along the driven shaft into a neutral position located intermediate of the forward and rearward positions. In the neutral position, the drive gear 42 does not engage either of the driven gears 44 or 46 such that the motor 28 is permitted to operate while the flight is not rotated. The neutral position is particularly useful for warming up the motor 28 without the need to loosen any drive belts connecting the motor to the flight. Also, in the neutral position, the auger can be moved about from one location to another while the engine is running and the flight is disengaged so as not to rotate. This is useful for moving from one job to another in rapid succession.

The gear box 10 also operates effectively if the driven shaft 32 and drive shaft 36 were reversed. Coupling the driven shaft 32 to the motor while coupling the drive shaft 36 to the auger shaft 26 also allows the auger to be operated in both forward and reverse positions by simply deflecting the lever 62 between the two positions.

The gear box 10 also functions effectively if both the collar 50 and slide portion 48 of the driven shaft were to have a rectangular cross section for example. In further embodiments, the collar 50 may be keyed to the slide portion 48 while still permitting longitudinal sliding movement therebetween. The gear box 10 may further be arranged such that the drive gear is slidably mounted relative to the driven gears as opposed to the driven gears being mounted on a sliding collar. Various forms of actuators may also be used to shift the gears between the neutral, forward and rearward positions respectively without compromising the operation of the gear box.

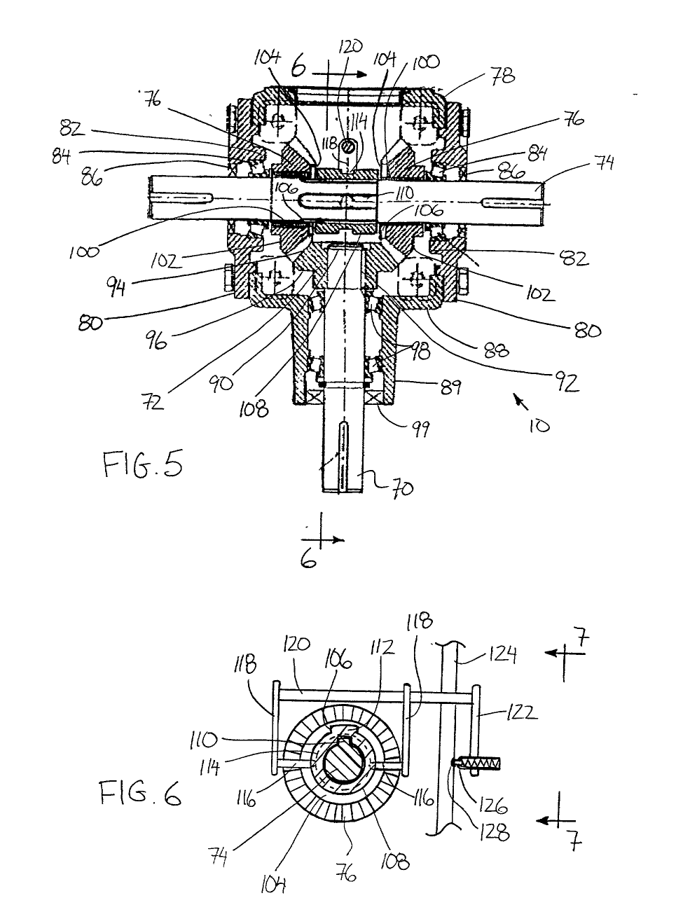

Turning now to FIGS. 5 through 7 a second embodiment of the gear box 10 is illustrated. The second embodiment of the gear box 10 similarly includes a main drive shaft 70 which mounts a main drive gear 72 thereon and a secondary driven shaft 74 supporting a pair of secondary driven gears 76 thereon. Also as in the first embodiment the gear box 10 is arranged to be connected between the motor and the flight of an auger for operation of the auger in forward, rearward and neutral positions as designated by the reference characters F, N and R respectively of FIG. 7.

In the second embodiment the gear box 10 includes a rectangular housing formed from steel plates which are bolted together to form a box-like structure permitting the housing to be readily assembled and disassembled as maintenance is required. As shown in FIG. 5 a pair of opposing side plates 80 of the housing each include an aperture formed centrally therein which is arranged to receive the secondary driven shaft 74 therethrough. The aperture in each side plate 80 includes an annular flange 82 formed therein defining a sleeve which permits a bearing 84 to be mounted at an inner end thereof and a packing seal 86 to be mounted adjacent an outer side thereof.

The bearings 84 in the opposing side plates 80 are tapered roller bearings which are oriented to oppose one another with a narrow end of the rollers of each bearing facing outwardly. The bearings 84 support the secondary shaft 74 to extend through the housing in a rotatable yet secure manner. The packing seals 86 which are mounted about the secondary driven shaft 74 externally of the two bearings 84 ensure that appropriate lubricant is retained within the housing of the gear box while debris and the like is restricted from entering.

A front side plate 88 of the housing spans between the opposing side plates 80 along a front side of the gear box and includes a collar 89 formed therein. The collar 89 is centrally located and oriented such that a longitudinal axis of the collar extends at radially outwardly from the secondary driven shaft 74 for supporting the main drive shaft 70 rotatably therein with a free end 90 of the main drive shaft 70 terminating perpendicularly to the secondary driven shaft 74 adjacent thereto with a slight spacing therebetween.

The main drive gear 72 is mounted on the free end 90 of the main drive shaft 70 at a fixed longitudinal position thereon with a spline connection 92 between the main drive gear 72 and the main drive shaft 70 to ensure that the main drive gear always rotates with the main drive shaft in operation. An inner face 94 of the main drive gear 72 is bevelled at an angle of approximately 45 degrees so as to mesh with respective inner faces of both secondary driven gears 76 which are similarly bevelled at approximately 45 degrees. Continuous engagement of the main drive gear 72 with the secondary driven gears 76 prevents longitudinal displacement of the main drive gear inwardly towards the secondary driven shaft 74 while an outer face 96 of the main drive gear 72 engages one of a pair of bearings 98 supporting the main drive shaft 70 to restrict sliding movement of the main drive gear 72 away from the secondary driven shaft and gears in operation.

The bearings 98 are mounted within the collar 89 of the front side plate 88 for supporting the main drive shaft 70 rotatably therein. The bearings 98 comprise a pair of tapered roller bearings at longitudinally spaced positions along the main drive shaft 70 which are oriented to oppose one another. A packing seal 99 is mounted about the main drive shaft 70 adjacent an outer end of the collar 89 for retaining lubricant within the gear box housing while restricting debris and the like from entering.

An inner one of the bearings 98 adjacent the outer face 96 of the main drive gear is oriented in a direction such that a narrow end of each of the rollers of the tapered roller bearing faces away from the main drive gear so as to be urged against the outer face 96 of the main drive gear in operation. The main drive gear is thus securely held in continuous engagement with the secondary driven gears 76 by the inner one of the bearings 98.

The secondary driven gears 76 are rotatably supported on the secondary driven shaft 74 by respective bearings 100 mounted therebetween. The secondary driven gears 76 are supported on the respective shaft at a fixed spacing in continuous engagement with the main drive gear 72 on diametrically opposed sides thereof. The inner bevelled face of each secondary driven gear meshes with the corresponding inner face 94 of the main drive gear 72 in operation to restrict longitudinal sliding movement of the secondary driven gears inwardly towards one another.

The bearings 84 supporting the secondary driven shaft 74 are arranged to engage the respective outer faces 102 of the secondary driven gears 76 to restrict longitudinal sliding movement of the secondary driven gears away from each other to ensure continuous engagement with the main drive gear. The bearings 84 as noted above are tapered roller bearings which are oriented such that a narrow end of each roller tapers outwardly so that the bearing is urged inwardly adjacent the outer faces 102 of the respective secondary driven gears 76 to ensure a compact and tight engagement of the gears in operation.

Each of the secondary driven gears 76 includes an inner flat annular portion 104 defined between the secondary driven shaft 74 and a bevelled toothed portion of each respective secondary driven gear 76. The inner flat annular portion 104 includes a socket 106 formed therein which is arranged to selectively engage the respective secondary driven gears 76 with the respective secondary driven shaft 74 for rotation therewith when engaged.

A sliding member 108 in the form of a collar is slidably mounted about the secondary driven shaft 74 between the secondary driven gears 76 for selective engagement with either one of the sockets 106 of the respective gears. The sliding member 108 has a length which is equal or less than a spacing between the secondary driven gears 76 such that the sliding member 108 is permitted to only engage one of the driven gears 76 at any given longitudinal position along the secondary driven shaft 74 as well as permitting an intermediate neutral position as shown in FIG. 5 in which the sliding member does not engage either of the secondary driven gears 76.

The sliding member 108 includes an internal key way which receives a spline 110 extending from the shaft 74 such that the shaft 74 and the internal diameter of the sliding member 106 have a mating cross section so as to permit longitudinal sliding movement along the shaft therebetween while restricting relative rotation of the sliding member about the secondary driven shaft 74.

An external spline 112 extends along an outer side of the sliding member 108 at both ends thereof and is arranged to align with respective key ways in the sockets 106 of the secondary driven gears 76 such that the sockets 106 of the driven gears 76 have a mating cross section with the ends of the sliding member 108 to restrict relative rotation therebetween when the sliding member is engaged within one of the respective sockets 106 while permitting longitudinal sliding movement of the sliding member into and out of engagement with either of the sockets 106.

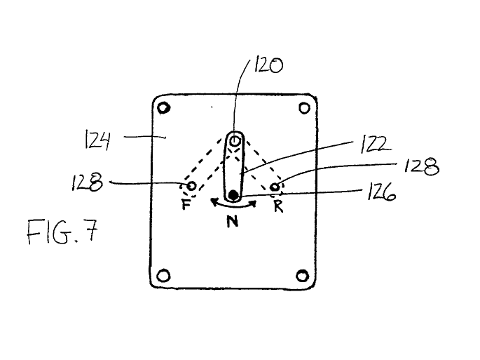

An actuator is provided for controlling the longitudinal position of a sliding member 108 along the secondary driven shaft 74 as illustrated in FIG. 6. The sliding member 108 includes an annular groove 114 centrally located on the sliding member to extend a full 360 degrees about the sliding member through the external spline 112 as well. A pair of diametrically opposed brass pins 116 are oriented to extend radially outwardly from the secondary driven shaft 74 with the free ends of the pins 116 being arranged to ride within the annular groove 114 as the sliding member 108 and shaft upon which it is mounted are rotated.

The pins 116 remain fixed in relation to the housing in operation so that the free ends of the pins 116 act as a bearing surface which provide a rotatable coupling between the actuator and the sliding member to permit relative rotation therebetween while restricting longitudinal sliding movement of the sliding member 108 by restricting the pins 116 within the annular groove 114.

The pins 116 are each held by a carrier arm 118 which supports the pin thereon at a free end thereof while being mounted at an opposite end on a common actuator rod 120. The actuator rod 120 extends perpendicularly to the secondary driven shaft 74 spaced radially outwardly therefrom opposite the main drive shaft 70 with each of the carrier arms 118 extending from the rod 120 towards the main drive shaft 70 spaced from the secondary driven shaft 74 on opposing sides thereof.

Pivoting the actuator rod 120 about a longitudinal axis thereof causes the free ends of the carrier arms 118 and the pins 116 mounted thereon to follow a prescribed arc-shaped path which extends primarily in the longitudinal direction of the secondary driven shaft 74 at a point where the pins 116 engage the shaft. An actuator lever 122 is mounted externally from the housing 178 for controlling pivotal displacement of the actuator rod 120.

As shown in FIG. 6 the actuator rod 120 projects through one of the side plates of the housing 78 at one end thereof for mounting the actuator lever 122 thereon. The actuator lever 122 lies in a perpendicular plane to the actuator rod 120 such that displacement of the free end of the actuator lever 120 within that plane causes the actuator rod 120 to be pivoted between the forward, rearward and neutral positions as indicated by reference characters F, R and N in FIG. 7.

The position of the free end of the actuator lever 122 relative to the respective end plate 124 of the housing is controlled by a spring loaded pin 126 arranged to ride along the outer surface of the end plate 124. A recess 128 is formed in the outer surface of the end plate 124 for receiving the pin 126 therein at each of the positions of the actuator lever 122 to hold the lever 122 in that position until the pin 126 is manually released from a respective recess 128 corresponding to a respective one of the forward, rearward or neutral positions.

When in use, pivoting the actuator lever 122 into the forward position such that the pin 126 is engaged within a respective one of the recesses 128 will pivot the actuator rod 120 and thus displace the sliding member 108 to engage a forward one of the secondary driven gears 76. In the forward position the forward gear is thus engaged to rotate with the secondary shaft and is also engaged with the main gear such that rotation of the main shaft in a forward direction corresponds to rotation of the secondary shaft also in a forward direction.

When it is desirable to reverse operation of the flight of the auger connection between the gear box and the flight of the auger is first loosened by loosening appropriate belts and such connected therebetween so that direction of the secondary shaft may be reversed. This is accomplished by deflecting the actuator lever 122 into the reverse position as shown in dotted line in FIG. 7 at which point the actuator rod has been rotated so that the sliding member 108 is deflected away from the forward gear into engagement with a rearward one of the secondary driven gears 76.

In the rearward position the rearward one of the gears is thus engaged to rotate with the secondary shaft as well as being engaged with the main gear such that rotation of the main shaft in the forward direction corresponds to rotation of the secondary shaft in a rearward direction opposite to the forward direction of the secondary shaft in the forward position of the sliding element. The opposite rotation is accomplished because mounting of the forward and rearward secondary driven gears 76 on opposing sides of the main drive gear 72 ensures that the driven gears 76 always rotate in opposite directions. Rotation of the shaft upon which they are rotatably supported is thus controlled by selecting which of the driven gears 76 the driven shaft 74 is rotated with.

In other instances, such as when it is desirable to warm up the motor of the auger without rotating the flight of the auger, the use of the neutral position of the gear box 10 is desirable. In the neutral position the actuator lever 122 is displaced into an intermediate neutral position between the forward and rearward positions as shown in FIG. 7 so that the sliding member is spaced between the secondary driven gears 76 without engagement with either one so that both the driven gears 76 rotate freely about the secondary driven shaft 74 and the secondary driven shaft 74 thus rotates independently of the main drive shaft 70. The secondary driven shaft 74 coupled to the flight of the auger can thus be stopped while the main drive shaft 70 continues to rotate with the motor which is operating.

In further embodiments a neutral position may not be required. Also depending on the application different arrangements of bearings and the like may be employed. In particular the actuator may require only a single pin 116 for controlling longitudinal sliding movement of the sliding member 108.

While some embodiments of the present invention have been described in the foregoing, it is to be understood that other embodiments are possible within the scope of the invention. The invention is to be considered limited solely by the scope of the appended claims.

1. A gear box for use with an auger comprising an elongate auger housing, a flight mounted in the auger housing for rotation about a longitudinal axis and a motor having an output for driving rotation of the flight, the gearbox comprising:
a gear box housing;
a main shaft rotatably mounted within the gear box housing;
a main gear mounted on the main shaft;
a secondary shaft rotatably mounted within the gear box housing;
a pair secondary gears including a forward gear and a rearward gear mounted spaced apart on the secondary shaft, and
a sliding element mounted on the secondary shaft and arranged to couple the secondary gears to the secondary shaft, the sliding element being slidably movable in a longitudinal direction of the secondary shaft between:
a forward position in which the forward gear is engaged to rotate with the secondary shaft and the forward gear is engaged with the main gear such that rotation of the main shaft in a forward direction corresponds to rotation of the secondary shaft in a forward direction; and
a rearward position in which the rearward gear is engaged to rotate with the secondary shaft and the rearward gear is engaged with the main gear such that rotation of the main shaft in the forward direction corresponds to rotation of the secondary shaft in a rearward direction opposite to the forward direction of the secondary shaft in the forward position of the sliding element;
one of the main shaft and the secondary shaft being arranged to be coupled to the output of the motor for rotation therewith and the other shaft being arranged to be coupled to the flight of the auger for rotation therewith.

2. The gear box according to claim 1 wherein the main shaft extends substantially perpendicularly to the secondary shaft and terminates at a free end adjacent to the secondary shaft.

3. The gear box according to claim 1 wherein the main gear and the pair of secondary gears each comprise a bevel gear.

4. The gear box according to claim 1 wherein the forward gear and the rearward gear engage respective opposing sides of the main gear in the forward and rearward positions respectively.

5. The gear box according to claim 1 wherein the main shaft is arranged to be coupled to the output of the motor for rotation therewith and the secondary shaft is arranged to be coupled to the flight of the auger for rotation therewith.

6. The gear box according to claim 1 wherein the sliding element is movable into a neutral position, intermediate of the forward position and the rearward position, in which main shaft rotates independently from the secondary shaft.

7. The gear box according to claim 1 wherein there is provided an actuator coupled to the sliding element, the actuator being arranged to control a longitudinal position of the sliding element along the secondary shaft between the forward and rearward positions.

8. The gear box according to claim 7 wherein there is provided a bearing coupled between the actuator and the sliding element permitting the sliding element to rotate freely with the secondary shaft while restricting a longitudinal positioning of the sliding element along the shaft.

9. The gear box according to claim 7 wherein the actuator is arranged to be coupled to the sliding element on diametrically opposing sides of the sliding element.

10. The gear box according to claim 1 wherein the sliding element is coupled to the secondary shaft for rotation therewith while permitting relative sliding movement therebetween in a longitudinal direction of the secondary shaft.

11. The gear box according to claim 1 wherein the main shaft and the secondary shaft-are rotatably supported on the housing by respective roller bearings.

12. The gear box according to claim 1 wherein both the secondary gears are engaged with the main gear in both the forward and rearward positions of the sliding element.

13. The gear box according to claim 12 wherein the secondary gears are arranged for rotation in opposite directions about the secondary shaft.

14. The gear box according to claim 12 wherein the sliding element is selectively coupled to the forward and rearward gears for rotation with a respective one of the forward and rearward gears in the forward and rearward positions respectively.

15. The gear box according to claim 12 wherein the secondary gears are rotatably supported on the secondary shaft by respective bearings.

16. The gear box according to claim 12 wherein each of the secondary gears includes a socket at one end thereof arranged to receive an end of the sliding element therein having a mating cross section for rotation together in a respective one of the forward and rearward positions.

17. The gear box according to claim 12 wherein the sliding element is supported on the secondary shaft between the secondary gears and is arranged to engage at most only one of the secondary gears at any given longitudinal position along the secondary shaft.

18. The gear box according to claim 1 wherein the sliding element mounts the secondary gears on the secondary shaft for rotation with the secondary shaft while permitting sliding movement of the secondary gears along the secondary shaft in a longitudinal direction of the shaft with the sliding element between the forward and rearward positions thereof.

19. The gear box according to claim 18 wherein the sliding element and the secondary shaft have respective mating cross sections for restricting relative rotational movement while permitting longitudinal sliding movement therebetween.

20. The gear box according to claim 18 wherein there is provided an actuator arranged to control a longitudinal position of the sliding element and secondary gears mounted thereon along the secondary shaft.
